(19) United States
(12) Patent Application Publication
(10) Pub. No.: US 2007/0056900 A1
(43) Pub. Date: Mar. 15, 2007

(54) Use of copolymers containing n-vinyl lactam for producing functionalized membranes

(75) Inventors: Klemens Mathauer, Heidelberg (DE); Tanja Schneider, Bensheim (DE); Ralf Widmaier, Mannheim (DE); Andre Kamm, Kottenheim (DE); Carl-Martin Bell, Reutlingen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/571,937

(22) PCT Filed: Sep. 14, 2004
(86) PCT No.: PCT/EP04/10243

§ 371 Date: Mar. 15, 2006

(30) Foreign Application Priority Data
Sep. 19, 2003 (DE) 103 43 900.5

(51) Int. Cl. B01D 71/40; C08F 8/30

(52) U.S. Cl. 210/500.1; 525/126

(57) ABSTRACT

The use of copolymers containing a) from 60% to 99% by weight of at least one vinyllactam or N-vinylamine selected from the group consisting of N-vinylpyrrolidone, N-vinylpiperidone, N-vinylcaprolactam or N-vinylformamide, and
b) from 1% to 40% by weight of at least one monomer of the general formula 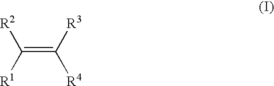 where
b1) R¹, R², R³ each denote oxygen, C₁-C₄-alkyl, C₆-aryl, C₇-C₁₀-alkylaryl and
   R⁴ denotes the general formula II 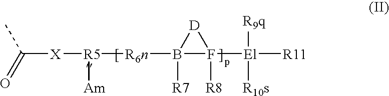 X denotes oxygen, NH, NR (where R=R1)
   R⁵ denotes C₁-C₆-alkyl, phenyl,
   A denotes OH, NH₂, NR₂ (wheret R₂=R1)
   R⁶, R⁷ R⁸ each denote hydrogen, C₁-C₄-alkyl n denotes an integer between 1 and 4 B, F each denote C, N
   D denotes C₁-C₄-alkyl, O, NH p denotes an integer between 0 and 15 E denotes N, O l, m each denote 0 or 1
   R⁹, R¹⁰, R¹¹ each denote hydrogen, C₁-C₄-alkyl, C₆-C₁₀-aryl, C₇-C₁₀-alkylaryl and s, q each denote an integer between 0 and 2. For E=nitrogen the s+q sum is equal to 1 or 2. For E=oxygen the s+q sum is equal to zero. For E=nitrogen and s+q=2 the counterions needed for charge neutrality are selected from elements of groups 1, 2 or 13 with the proviso that there is one element of group 1 per R4 radical when a group 1 element is selected, one element of group 2 per two R4 radicals when a group 2 element is selected and one element of group 13 per three R4 radicals when a group 13 element is selected.
b2) R¹, R², R³ each denote hydrogen, C₁-C₄-alkyl, C₆-aryl, C₇-C₁₀-alkylaryl or a radical of the general formula III
   R⁴ denotes a radical of the general formula III 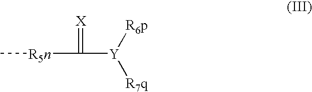
   R⁶, R⁷ each denote hydrogen, C₁-C₄-alkyl, C₆-aryl, C₇-C₁₀-alkylaryl X denotes O, NH, NR (where R=R6)
   R5 denotes C₁-C₁₀-alkyl, C₆-C₁₀-aryl, C₇-C₁₄-alkylaryl n denotes an integer between 0 and 15 Y denotes O, N
   R6, R7 each denote hydrogen, C₁-C₄-alkyl, C₆-aryl, C₇-C₁₀-alkylaryl
   p, q each denote an integer between 0 and 2 with the proviso that at least one of R¹, R², R³ and R⁴ but not more than two denote the general formula III.
b3) R¹, R², R³ each denote hydrogen, C₁-C₄-alkyl, C₆-aryl, C₇-C₁₀-alkylaryl
   R⁴ denotes a radical of the general formula IV 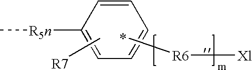
   R⁵ denotes C₁-C₈-alkyl n denotes an integer between 0 and 4 m, l each denote 0 or 1
   R⁶ denotes C₁-C₄-alkyl
   R⁷ denotes hydrogen, C₁-C₄-alkyl and X N(R1)(R2) or halogen.
b4) R¹, R², R³ each denote hydrogen, C₁-C₄-alkyl, C₆-aryl, C₇-C₁₀-alkylaryl
   R⁴ denotes a radical of the general formula V 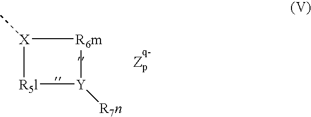 X, Y each denote O, N, S
   R⁵, R⁶ each denote C₁-C₄-alkyl, C₁-C₄-alkenyl l, m each denote an integer between 0 and 4 n denotes an integer between 0 and 2
   R⁷ denotes hydrogen, C₁-C₄-alkyl Z denotes sulfate, hydrogensulfate, chloride, bromide, iodide, phosphate, hydrogenphosphate, dihydrogenphosphate p denotes 0, ⅓, ½, 1 and q denotes an integer between 0 and 3.
b5) R¹, R², R³ each denote hydrogen, C₁-C₄-alkyl, C₆-aryl, C₇-C₁₀-alkylaryl, or a radical of the general formula VI
   R⁴ denotes a radical of the general formula VI 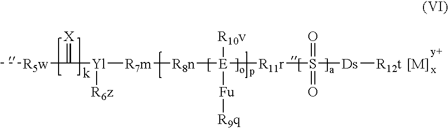
   R⁵, R⁷, R⁸, R¹¹ each denote C₁-C₆-alkyl, C₆-aryl, C₇-C₁₀-alkylaryl
   R⁶, R¹² each denote hydrogen, C₁-C₄-alkyl, C₆-aryl
   R⁹, R¹⁰ each denote hydrogen, C₁-C₄-alkyl, C₆-aryl, C₇-C₁₀-alkylaryl X denotes O E, F, Y, D each denote O, N, S M denotes an element of group 1, 2 or 13 of the periodic table a, k, l, s each denote 0 or 1 m, n, r, w each denote an integer between 0 and 10 o denotes an integer between 0 and 3 p denotes an integer between 0 and 20 q, t, u, v, z each denote an integer between 0 and 2 x denotes 0, ⅓, ½, 1 and
   y an integer between 1 and 3 with the proviso that at least one of R¹, R², R³ and R⁴ but not more than 2 denote the general formula VI, in conjunction with c) optionally one or more hydrophilic polymers C or mixtures thereof d) and optionally also further polymers D and mixtures thereof for producing membranes.

The present invention relates to the use of N-vinyllactam copolymers for producing membranes and also to processes for their production.

The present invention further relates to a semipermeable membrane comprising the copolymers described in the present invention.

The present invention further relates to the use of the polymers for solution diffusion membranes to be used in separation.

The present invention further provides novel copolymers, processes for their preparation and also their use in accordance with the present invention.

There are a multiplicity of technical applications which these days employ membranes. For instance, membranes are used to convert seawater into drinking water by reverse osmosis. Membranes are further useful for cleaning industrial wastewaters or for recovering materials of value, for example for recovering lacquers by ultrafiltration of audio tapes. Membranes are also intensively studied and in some instances already used for separating materials say in chemical syntheses as a replacement for known and energy-intensive techniques such as distillation. Membranes also find increasing application in the sectors of food technology, medicine and pharmaceutical technology. For instance, solutions of various macromolecules can be fractionated by means of membranes or, in hemodialysis, urea and toxins can be removed from the bloodstream. Membranes can similarly be used in the skin-controlled administration of drugs.

It is known that a membrane's morphology has a decisive influence over its field of use. Selectivity and permeability is defined by the surface structure and coating of a porous membrane, while a membrane's mechanical properties are influenced by its internal construction. It is therefore desirable to control a membrane's surface and internal structure in a specific manner through controlled combination of manufacturing process parameters. Important factors of influence such as the nature and composition of the polymers and solvents used for membrane formation are detailed in EP-A 0 168783.

When membranes are to be used in processes where they come into contact with a hydrophilic medium, the membrane surface has to have a certain degree of hydrophilicity and hence permit adequate wetting for the actual separation of materials to take place.

On the other hand, the separating performance can also be influenced by controlling the surface properties of a membrane.

Porous media are very useful in many kinds of applications in the field of separation and adsorption, such as chromatography say. Porous membranes are one example frequently used. The division into microporous and ultrafiltration membranes is done according to the pore size, which is generally defined as ranging between about 0.05 and 10 micrometers for microporous membranes and 0.002 to 0.05 micrometers for ultrafiltration membranes. The pore size here relates to circular or substantially circular pores or to characteristic variables of noncircular pores.

Pore size is determined by the size of the smallest particle, molecule, etc., which cannot pass through the membrane above a specified fraction. In general, the limit is deemed to be where less than 10 percent of material passes through, which corresponds to a 90 percent retention or cutoff. It is likewise possible to determine the pore size distribution by means of electron microscopy for example.

Microporous membranes are typically used for removing particles from liquids and gases, say sterile filtration to remove bacteria from pharmaceutical solutions or sterile filtration of gases.

Ultrafiltration membranes are generally used to remove smaller particles. Examples are the concentrating of proteins in solution in biotechnology, diafiltration to remove salts and low molecular weight impurities in protein solutions or the targeted removal of contaminants from blood, as also utilized in hemodialysis for extracorporal blood clearance. Depyrogenization removes especially pyrogens (substances such as for example lipopolysacccharide complexes which when given intravenously in very small amounts of about 0.2 mg/kg of body weight bring about a fever in higher animals and in humans; definition in accordance with Pschyrembel, “Klinisches Wörterbuch”, 257^{th} edition, de Gruyter (1994), page 1279) from contaminated infusion media prior to their application. The pyrogens are removed by filtration and/or by adsorption of the pyrogens on the filter medium.

Porous membranes can be produced from a multiplicity of different materials. Owing to the simple-to-achieve consistent product quality, polymers are preferred to naturally occurring materials.

Materials or polymers for producing membranes have been classified into reactive or hydrophilic materials on the one hand and inert materials on the other (I. Cabasso in “Membranes”, Encyclopedia of Polymer Science and Engineering, Wiley, 1987, 9, 509-579; R. Kesting, Synthetic Polymeric Membranes, Wiley, 1985, 2nd Edition). Reactive materials either have an intrinsic hydrophilicity or are fairly simple to make hydrophilic, which reduces the nonspecific binding of proteins to the membrane, but generally have limited mechanical and thermal properties. Inert materials, by contrast, possess excellent mechanical, thermal properties and are very resistant to chemical attacks, but are highly hydrophobic and hence are susceptible to nonspecific binding and hence deposition of proteins and consequential membrane fouling or clogging.

Commercial membranes are generally produced from engineering plastics such as polyether sulfones, polysulfones, polyvinylidene fluorides, polyethene, polypropene, polytetrafluoroethene, etc., owing to their marked resistance to thermal, mechanical and chemical stresses. Regrettably, these materials do not have the necessary properties to enable a direct use as a membrane material for pharmaceutical or biotechnological purposes, such as a certain hydrophilicity and hence wettability with aqueous solutions. Also, to some extent, the high affinity for biomolecules and hence the strong adsorption has an adverse effect on desired separating properties.

Wettability is necessary for membrane media to enable permeation of substances. The hydrophilicity needed for biomolecules can be achieved through use of a wetting liquid whose excess, however, has to be removed again by means of (cost-)intensive washing. Nevertheless, small residual amounts remain usually behind in the membrane and can leach out during use.

In applications having high purity requirements such as the pharmaceutical industry, membranes for the medical sector or the microelectronics industry for the manufacture of wafers, for example, the fraction of extractable material has to be very low in order that additional contamination may be avoided in use.

As well as permeability and the necessary retention, membranes have to have sufficient mechanical stability, according to the intended application, to be able to withstand operating conditions such as pressure and temperature.

These properties are customarily sought to be achieved by modifying the membrane surface, for example in order to achieve a hydrophilicization or a resistance to the deposition or adsorption of biomolecules.

To this end, the membrane material may be provided with hydrophilic groups by a chemical reaction or have a hydrophilic substance applied to the surface. This hydrophilic substance is usually a polymer because of the aforementioned problem of leaching, since polymeric entities are less quick to leach out than low molecular weight entities.

At the same time, however, these polymeric entities must not have properties which adversely affect membrane structure: the swelling of crosslinked polyacrylic acid, for example, would reduce the pore size. Moreover, these polymers have to be stable to the conditions of the particular application and must not have an overly adverse effect on properties of the membrane, for example its stability.

As well as for surface modification of membrane polymers for medical or technical applications, surface-altering polymers can also be used alone. For instance, papers and films for ink jet applications have a thin polymeric layer applied to them to quickly conduct the moisture (usually water or mixtures of water and oil) of the ink away from the surface in order that smudging of the printed ink may be avoided. In addition, the polymer may also be used for example to bind the dyes or pigments to the polymer and hence to enhance color fixation on the surface. Another use is the application of hydrogel-forming polymers to surfaces in order that an article. may be rendered lubricious for example.

The effect of surface modification through polymers and hence the change in surface properties is also useful for, for example, inhibiting crystallization of substances in liquid media and hence precipitation or fouling. For instance, scale inhibitors are used in water treatment to inhibit the deposition of salts in equipment. Polymers are used as an alternative to methanol or glycol in oil production to avoid the crystallization of clathrates or gas hydrates (inclusion of gases in ice) which is always found in the mixture of oil/natural gas. Organic solvents achieve this effect through temperature depression (thermodynamic inhibition of ice formation), whereas polymers interact with the surface of the ice and come to deposit on the surface of ice crystallite intermediates and thus greatly inhibit crystallite accretion and concretion (kinetic inhibition).

U.S. Pat. No. 4,051,300 describes the production of hollow fiber membranes from polysulfone and PVP having a very low molecular weight (Mw at least 2000 g/mol) by forming a spinning solution and then coagulating the membrane and subsequently washing it. The low molecular weight of PVP is said to ensure complete PVP removal from the membrane during washing.

EP-A 0 168 783 describes asymmetrical microporous hollow fiber membranes for blood treatment which comprise more than 90% by weight of a hydrophobic polysulfone matrix polymer and further contain 1% to 10% by weight of hydrophilic polyvinylpyrrolidone, are readily wettable with water and exhibit excellent biocompatibility in that the body's own defense system entities present in the blood do not react to the surface of the membranes. The incompatible hydrophilic polymers serve as pore-formers and are washed off the membrane after consolidation, except that a small fraction shall remain behind for the purposes of hydrophilicizing the otherwise hydrophobic membrane.

The remaining of a portion of the hydrophilic PVP in the matrix of the polysulfone is achieved in EP-A 0 168 783 by extruding the solution of the two polymers within a narrowly circumscribed viscosity range whereby the structure of the hollow-fiber extrudate is preserved until the fiber-forming polymer is coagulated and, at coagulation, the largest portion of the PVP used is washed out of the dope, leaving a portion behind in the membrane.

DE-A 19817364 describes the production of membranes having a predetermined hydrophilicity and porosity. A hydrophilic polymer having a bimodal molecular weight distribution is used. The low molecular weight fraction, which is more easily washed off after coagulation, is used for controlled adjustment of the porosity. The high molecular weight fraction, which is less readily washed off, determines the hydrophilicity of the membrane.

EP-A 0 550 798 discloses that membranes of the type obtained according to EP-A 0 168 783 for example still contain water-soluble PVP. Accordingly, it is unavoidable that these membranes on repeated use will each time release minimal amounts to the medium to be filtered. One of the consequences of this is that the retention ability of such membranes changes to less sharp cutoff. Ways of rendering the PVP in polysulfone membranes insoluble in water are described for example in EP-A 0 082 433 and EP-A 0 550 798. These references describe crosslinking by, respectively, chemical means and ionizing radiation.

EP-A 0 478 842 describes a membrane filter layer composed of inert polymeric materials of construction, such as polyethene, polypropene, nylon-6,6, polycaprolactam, polyester or polyvinylidene fluoride for example, from each of which membranes for pyrogen removal are producible, the pore material used for the membrane filter layer preferably being a cationically or anionically modified polymer, since this provides an appreciable improvement in separation performance. An example of a cationically modified polymer used is nylon-6,6 whose surface is modified with polymers bearing quaternary ammonium groups. Carboxyl groups are preferred as a source of negative charge for anionically modified polymers.

EP 683691 describes cationically charged membranes useful for endotoxin removal. The membranes are produced by contacting a hydrophobic polymeric membrane, preferably composed of polysulfone, polyarylsulfone or polyethersulfone, with a quaternary wetting agent and then crosslinking, on the membrane, at least one cationic modifier for the membrane. In a further embodiment, the membrane is cast from a solution which contains polyethersulfone, a copolymer of vinylpyrrolidone and a cationic imidazolinium compound, preferably methylvinylimidazolidinium methosulfate, and a low molecular weight organic acid, the disclosed weight fractions of the casting solution which are attributable to the acid ranging from 24% to 34%. Therefore, the equipment which comes into contact with this casting solution has to be acid-resistant, which makes the equipment expensive.

The WO 94/17906 equivalent discloses hydrophilic charge-modified microporous membranes which have a crosslinked structure of interpenetrating networks (IPNs). The membrane consists of a homogeneous matrix of polyethersulfone, polyfunctional glycidyl ether, a polymeric amine such as polyethyleneimine (PEI), etc., and polyethylene glycol (PEG). Particular preference is given to the optional use of N-vinylpyrrolidone homo- or copolymers with dimethylaminoethyl methacrylate or mixtures thereof, more preferably a quaternized copolymer. The membrane has cationic charges and a low fraction of extractables. Likewise disclosed is the production of such a membrane by casting, precipitating and washing to form the IPN. A PVP homopolymer (Mw=700.00 g/mol, K value 90) guarantees a long-lasting hydrophilicity and a copolymer additionally an increased an increased charge capacity.

EP 054799 describes the fixing of γ-globulin on polyacrylamide, silica, polyvinyl alcohol or polysaccharides for extracorporal blood clearing. All these carriers have specific disadvantages, which have negative repercussions for body fluids on prolonged contact therewith.

GB-B-2092470 discloses the removal of pyrogens from solutions using a nitrogenous compound fixed on an insoluble carrier selected from polysaccharides, hydroxyalkylpolystyrene and hydroxyalkylpolystyrene-divinylbenzene copolymer. These carriers are not biocompatible.

EP 1110596 describes a process for producing pore-free or preferably porous shaped articles for pyrogen retention. When pore-free, the shaped article is usable as an adsorption medium in fine granulation in column form. When porous, the shaped article is permeable to at least some of the pyrogens, especially when the shaped article is in the form of a semipermeable flat, hose or hollow fiber membrane. The shaped article is hydrophilic and consists of a synthetic polymeric component and an additive which is a copolymer of vinylpyrrolidone and a vinylimidazole compound in ratios from 90:10 to 10:90, but preferably 50:50. The additive is sufficiently adherent to the synthetic polymer for many applications. To increase the adhesion, crosslinking of the additive is described as preferable. The hydrophilicization of the shaped article can also be accomplished by wetting with ethanol for example, but permanent hydrophilicization is preferred. The synthetic polymeric component used is preferably a hydrophilic polymer or a hydrophobic polymer which has been rendered hydrophilic by chemical modification, examples being various polyamides or sulfonated polyethersulfone. A further particularly preferred embodiment utilizes a hydrophobic polymer, for example a polysulfone, polyethersulfone, polyarylethersulfone, polyacrylonitrile, polycarbonate or polyolefin, and hydrophilic polymer selected from the group of the polyvinylpyrrolidones, polyether glycols, polyvinyl alcohols or sulfonated polyethersulfones.

EP 0103184 describes biospecific polymers having immobilized reactive biomolecules thereon which are capable of binding factors of the complement system having pathological properties with high activity. The medium is composed of a biocompatible terpolymer polymerized from glycidyl methacrylate, N-vinylpyrrolidone and hydroxyethyl methacrylate as well as the biomolecules mentioned. Also disclosed is the preparation of such biocompatible polymers on a mechanical carrier as a support. The extracorporal clearing of body fluids such as blood is mentioned as an application.

EP 046136 describes the preparation and use of gradient interpenetrating networks (GIPNs) which are formed from a hydrogel-forming polymer and a less permeable condensation polymer by forming the condensation polymer (polyurethane, polyester, polyamide, polyimide, polyurea or polyimine) within the hydrogel by condensation of the monomers. The condensation polymer provides mechanical stabilization for the hydrogel by forming the GIPN and thereby makes it possible for the GIPN to be formed as a membrane in the form of a layer, film, tube or hollow fiber membrane and can in particular be used in the form of the latter for membrane separation processes such as for example reverse osmosis, dialysis, electrophoresis, solvent-water separation processes as take place in wastewater treatment. Moreover, such a hydrogel can be used as an active agent dispenser.

U.S. Pat. No. 5,462,867 describes the use of reactive end groups which virtually any polymer possesses as a result of the polymerization reaction, for functionalizing the polymer by covalent bonding of compounds (linkers) to these functional groups having particular benefit for the modification of hydrophobic polymers for membrane applications. These linkers are then capable of binding ligands or other macromolecules. Examples mentioned include polyethersulfone and polysulfones in conjunction with polyvinylpyrrolidone of medium molar mass (360.000 g/mol).

Chapman et al. (J. Am. Chem. Soc. 2000, 122, 8303-8304) describe the use of self-assembled monolayers (SAMs) for screening of functional groups which possess resistance to proteins.

U.S. Pat. No. 4,695,592 and U.S. Pat. No. 4,678,813 both describe a process and its product for use for a hydrophilicized porous membrane composed of polyolefins in conjunction with a cross-linked polymer containing 50% or more of diacetone acrylamide units.

WO 98/01208 describes a charge-modified polymeric membrane which comprises a hydrophobic polymer, such as sulfone polymers such as polysulfone, polyarylsulfone or polyethersulfone for example, and is hydrophilicized by means of a polymeric wetting agent such as polyvinyl alcohol or a cellulosic polymer having hydrophilic functional groups and at least one cationic charge-modifying agent which is crosslinked on the hydrophobic polymer. These polymeric membranes can be used in the form of a flat sheet membrane, hollow fiber membrane, a cast or melt-blown membrane or any other desired suitable form for use in membrane cartridges. Crosslinking is effected by the action of energy such as for example by irradiation or heating to 70-200° C. or by free radical initiator. These membranes can find use in a multiplicity of applications, including the filtration of water or fluids for the electronics, pharmaceutical or biological industry or else blood filtration.

The production of physical polymer blends from a matrix polymer and a “functional” polymer whose desired properties and functional groups are to be effective in the polymer blend is described in a multiplicity of publications (U.S. Pat. No. 3,629,170, U.S. Pat. No. 4,387,187, U.S. Pat. No. 3,781,381, etc.), in some instances with an additional crosslinking step (U.S. Pat. No. 4,596,858, Gryte et al., J. Applied Polymer Sci. 1979, 23, 2611-2625, etc.).

WO 02/087734 describes porous media or membranes by means of a surface coating which confers specific properties such as low absorption of biomolecules, resistance to alkali, etc. on the membrane or porous medium. The surface coating consists of a terpolymer consisting of vinylpyrrolidone or derivatives, (meth)acrylamide or derivatives and a crosslinker. Membrane materials used include for example polysulfone or polyethersulfone. All commonly used membrane types such as for example hollow fiber flat sheet membranes etc. are disclosed. A further modification can be achieved through the use of specific monomers such as for example 2-acrylamido-2-methylpropanesulfonic acid or hydroxymethyl diacetone acrylamide.

U.S. Pat. No. 4,729,914 describes the preparation and use of hydrophilic coatings which are very difficult to detach again from a substrate. This is achieved by the substrate, which bears free isocyanate groups, being coated with a vinylpyrrolidone copolymer whose comonomers bear active hydrogen atoms which in turn are capable of reacting with the isocyanate groups of the substrate whereby the vinylpyrrolidone copolymer becomes chemically bound to the substrate. This avoids detachment of the vinylpyrrolidone copolymer on contact with hydrophilic solvents such as for example alcohol or water. Possible comonomers mentioned include for example monomers which contain hydroxyl, imine, carboxyl or thiol groups.

It is an object of the present invention to specifically modify the surface of membranes based on polysulfones, for example polyethersulfone (Ultrason® E), polysulfone (Ultrason® S) or polyarylsulfone, to introduce reactive groups which are capable of entering a chemical reaction or strong interactions with biomolecules in particular in order to achieve, through the binding or interaction, a distinctly improved separation of flowing streams such as for example blood (in the sense of selective removal of toxins or pathogens) without significantly altering the properties of common Ultrason®-PVP polymer blend membranes.

We have found that this object is achieved by the use of copolymers containing
a) from 60% to 99% by weight of at least one vinyllactam or N-vinylamine selected from the group consisting of N-vinylpyrrolidone, N-vinylpiperidone, N-vinylcaprolactam or N-vinylformamide, and
b) from 1% to 40% by weight of at least one monomer of the general formula I 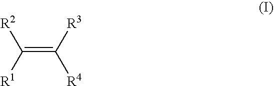
   where
b1) R1, R2, R3 each denote hydrogen, C₁-C₄-alkyl, C₆-aryl, C₇-C₁₀-alkylaryl,
   R4 denotes the general formula II 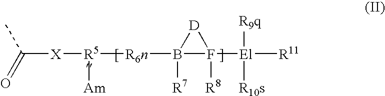
   X denotes oxygen, NH, NR (where R=R1)
   R⁵ denotes C₁-C₆-alkyl, phenyl,
   A denotes OH, NH₂, NR₂ (where R₂=R1)
   R⁶, R⁷, R⁸ each denote hydrogen, C₁-C₄-alkyl
   n denotes an integer between 1 and 4
   B, F each denote C, N
   D denotes C₁-C₄-alkyl, O, NH
   p denotes an integer between 0 and 15
   E each denote N, O
   l, m each denote 0 or 1
   R⁹, R¹⁰, R¹¹ each denote hydrogen, C₁-C₄-alkyl, C₆-C₁₀-aryl, C₇-C₁₀-alkylaryl and
   s, q each denote an integer between 0 and 2.
   For E=nitrogen the s+q sum is equal to 1 or 2. For E=oxygen the s+q sum is equal to zero.

For E=nitrogen and s+q=2 the counterions needed for charge neutrality are selected from elements of groups 1, 2 or 13 with the proviso that there is one element of group 1 per R4 radical when a group 1 element is selected, one element of group 2 per two R4 radicals when a group 2 element is selected and one element of group 13 per three R4 radicals when a group 13 element is selected.
b2) R¹, R², R³ each denote hydrogen, C₁-C₄-alkyl, C₆-aryl, C₇-C₁₀-alkylaryl or a radical of the general formula III
   R⁴ denotes a radical of the general formula III 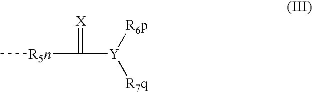
   R⁶, R⁷ each denote hydrogen, C₁-C₄-alkyl, C₆-aryl, C₇-C₁₀-alkylaryl
   X denotes O, NH, NR (where R=R⁶)
   R⁵ denotes C₁-C₁₀-alkyl, C₆-C₁₀-aryl, C₇-C₁₄-alkylaryl
   n denotes an integer between 0 and 15
   Y denotes O, N
   R⁶, R⁷ each denote hydrogen, C₁-C₄-alkyl, C₆-aryl, C₇-C₁₀-alkylaryl
   p, q each denote an integer between 0 and 2 with the proviso that at least one of R¹, R², R³ and R⁴ but not more than two denote the general formula III.
b3) R¹, R², R³ each denote hydrogen, C₁-C₄-alkyl, C₆-aryl, C₇-C₁₀-alkylaryl
   R⁴ denotes a radical of the general formula IV 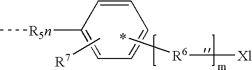
   R⁵ denotes C₁-C₈-alkyl
   n denotes an integer between 0 and 4
   m, l each denote 0 or 1
   R⁶ denotes C₁-C₄-alkyl
   R⁷ denotes hydrogen, C₁-C₄-alkyl and
   X denotes N(R1)(R2) or halogen.
b4) R¹, R², R³ each denote hydrogen, C₁-C₄-alkyl, C₆-aryl, C₇-C₁₀-alkylaryl
   R⁴ denotes a radical of the general formula V 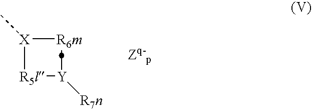
   X, Y each denote O, N, S
   R⁵, R⁶ each denote C₁-C₄-alkyl, C₁-C₄-alkenyl
   l, m each denote an integer between 0 and 4
   n denotes an integer between 0 and 2
   R⁷ denotes hydrogen, C₁-C₄-alkyl
   Z denotes sulfate, hydrogensulfate, chloride, bromide, iodide, phosphate, hydrogenphosphate, dihydrogenphosphate
   p denotes 0, ⅓, ½, 1 and
   q denotes an integer between 0 and 3.
b5) R¹, R², R³ each denote hydrogen, C₁-C₄-alkyl, C₆-aryl, C₇-C₁₀-alkylaryl, or a radical of the general formula VI
   R⁴ denotes a radical of the general formula VI 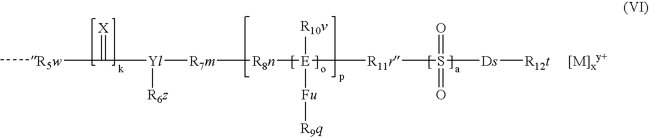
   R⁵, R⁷, R⁸, R¹¹ each denote C₁-C₆-alkyl, C₆-aryl, C₇-C₁₀-alkylaryl
   R⁶, R¹² each denote hydrogen, C₁-C₄-alkyl, C₆-aryl
   R⁹, R¹⁰ each denote hydrogen, C₁-C₄-alkyl, C₆-aryl, C₇-C₁₀-alkylaryl
   X denotes O
   E, F, Y, D each denote O, N, S
   M denotes an element of group 1, 2 or 13 of the periodic table
   a, k, l, s each denote 0 or 1
   m, n, r, w each denote an integer between 0 and 10
   o denotes an integer between 0 and 3
   p denotes an integer between 0 and 20
   q, t, u, v, z each denote an integer between 0 and 2
   x denotes 0, ⅓, ½, 1 and
   y an integer between 1 and 3 with the proviso that at least one of R¹, R², R³ and R⁴ but not more than 2 denote the general formula VI, and also optionally one or more hydrophilic polymers C or mixtures thereof and optionally also further polymers D and mixtures thereof to produce membranes.

The inventive copolymers are preparable by copolymerization of the monomers according to commonly employed polymerization processes. But graft copolymerization is also possible. In graft copolymerization, an already extant polymer has further monomers free-radically polymerized (grafted) onto it, so that the existing polymer sprouts polymeric side chains formed from the monomer used. Ungrafted polymers are also formed to a certain extent.

The polymer which is grafted (backbone, grafting base) can be not only a homo- but also a copolymer, terpolymer, etc. formed from the inventive monomers. The monomers used for grafting are chosen singly or as a mixture from the inventive monomers a), the monomers b) or as a mixture of two or more monomers from the monomers a) and b). Preference for use in the realm of this invention is given to copolymers obtained by copolymerization according to commonly employed polymerization processes.

When using vinylamine as a comonomer, it must be noted that the structurally simplest vinylamine, viz. N-vinylamine, cannot be polymerized as such (unlike the triply substituted N,N,N-vinyl-R1-R2-amines), since it exists virtually completely in the form of its tautomer, viz. ethylimine. N-Vinylamine, however, can be polymerized according to known methods when it is in the form of its derivative, viz. vinylformamide. The vinylformamide polymers formed can then be partly or wholly converted into the corresponding vinylamine polymers by hydrolysis of the formamide groups as described in EP 71050 to BASF for example. The hydrolysis can take place directly following polymerization, in the same reaction vessel, or in another, separate reaction step.

Therefore, the reference herein to vinylamine monomer is always to be understood as meaning the use of the corresponding vinylformamide derivatives with subsequent hydrolysis. A copolymer constructed of for example 50 mol % each of vinylformamide and vinylamine consequently is to be understood as referring to a polymer which was polymerized from 100% vinylformamide and 50% of whose vinylformamide groups were subsequently hydrolyzed to vinylamine.

Component a) of the N-vinyllactams or N-vinylamines is preferably selected from the group consisting of N-vinylpyrrolidone, N-vinylpiperidone, N-vinylcaprolactam, N-vinylimidazole, N-vinyl-2-methylimidazole, N-vinyl-4-methylimidazole and N-vinylformamide and is more preferably N-vinylpyrrolidone.

The fraction of monomeric building blocks a) in the copolymer is in the range from 60% to 99% by weight, preferably in the range from 70% to 97% by weight and more preferably in the range from 75% to 95% by weight.

As components b) there may be mentioned the following comonomers:
b1) R¹, R², R³ denote hydrogen, C₁-C₄-alkyl, C₆-aryl, C₇-C₁₀-alkylaryl and
   R4 denotes the general formula II 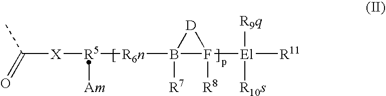
   X denotes oxygen, NH, NR (where R═R¹)
   R⁵ C₁-C₆-alkyl, phenyl (better “C₆-aryl”?),
   A OH, NH₂, NR₂ (where R₂=R1)
   R⁶, R⁷, R⁸ each denote hydrogen, C₁-C₄-alkyl
   n denotes an integer between 1 and 4
   B, F each denote C, N
   D denotes C₁-C₄-alkyl, O, NH
   p denotes an integer between 0 and 15
   E denotes N, O
   l, m each denote 0 or 1
   R⁹, R¹⁰, R¹¹ each denote hydrogen, C₁-C₄-alkyl, C₆-C₁₀-aryl, C₇-C₁₀-alkylaryl and
   s, q each denote an integer between 0 and 2.
   For E=nitrogen the s+q sum is equal to 1 or 2. For E=oxygen the s+q sum is equal to zero.

For E=nitrogen and s+q=2 the counterions needed for charge neutrality are selected from elements of groups 1, 2 or 13 with the proviso that there is one element of group 1 per R4 radical when a group 1 element is selected, one element of group 2 per two R4 radicals when a group 2 element is selected and one element of group 13 per three R4 radicals when a group 13 element is selected.

Component b1) is preferably glycidyl methacrylate (GMA) or hydroxyethyl methacrylate (HEMA).
b2) R¹, R², R³ each denote hydrogen, C₁-C₄-alkyl, C₆-aryl, C₇-C₁₀-alkylaryl or a radical of the general formula III
   R⁴ denotes a radical of the general formula III 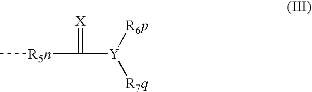
   R⁶, R⁷ each denote hydrogen, C₁-C₄-alkyl, C₆-aryl, C₇-C₁₀-alkylaryl
   X denotes O, NH, NR (where R=R6)
   R⁵ denotes C₁-C₁₀-alkyl, C₆-C₁₀-aryl, C₇-C₁₄-alkylaryl
   n denotes an integer between 0 and 15
   Y denotes O, N
   R⁶, R⁷ each denote hydrogen, C₁-C₄-alkyl, C₆-aryl, C₇-C₁₀-alkylaryl
   p, q each denote an integer between 0 and 2 with the proviso that at least one of R¹, R², R³ and R⁴ but not more than two denote the general formula III.

Preferably, b2) is acrylic acid (AS), methacrylic acid (MAS), crotonic acid (CS), dimethylacrylamide (DMAA), 10-undecenoic acid (UDS), 4-pentenoic acid (PS), cinnamic acid (ZS), maleic acid (MS) or maleic anhydride (MSA), fumaric acid, 3-butenoic acid, 5-hexenoic acid, 6-heptenoic acid, 7-octenoic acid, citraconic acid, mesaconic acid, itaconic acid.
b3) R¹, R², R³ each denote hydrogen, C₁-C₄-alkyl, C₆-aryl, C₇-C₁₀-alkylaryl
   R⁴ denotes a radical of the general formula IV 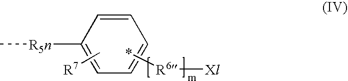
   R⁵ denotes C₁-C₈-alkyl
   n denotes an integer between 0 and 4
   m, l each denote 0 or 1
   R⁶ denotes C₁-C₄-alkyl
   R⁷ denotes hydrogen, C₁-C₄-alkyl and
   X denotes N(R1)(R2) or halogen.

Preferably, b3) is 4-vinylbenzyl chloride (VBC), 4-aminostyrene, 3-N,N-dimethylaminostyrene, 3-N,N-diethylaminostyrene, 3-N,N-diphenylaminostyrene, 4-N,N-dimethylaminostyrene, 4-N,N-diethylaminostyrene, 4-N,N-diphenylaminostyrene.
b4) R¹, R² R³ each denote hydrogen, C₁-C₄-alkyl, C₆-aryl, C₇-C₁₀-alkylaryl
   R⁴ denotes a radical of the general formula V 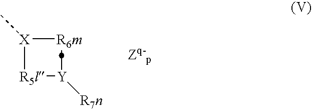
   X, Y each denote O, N, S
   R⁵, R⁶ each denote C₁-C₄-alkyl, C₁-C₄-alkenyl
   l, m each denote an integer between 0 and 4
   n denotes an integer between 0 and 2
   R⁷ denotes hydrogen, C₁-C₄-alkyl
   Z denotes sulfate, hydrogensulfate, chloride, bromide, iodide, phosphate, hydrogenphosphate, dihydrogenphosphate
   p denotes 0, ⅓, ½, 1 and
   q denotes an integer between 0 and 3.

Preferably b4) is vinylimidazole (VI) or quaternized vinylimidazole (QVI), 2-methylvinylimidazole, 4-methylvinylimidazole, 5-methylvinylimidazole or quaternized derivatives thereof. Particular preference is given to a terpolymer using vinylimidazole, quaternized vinylimidazole or N-vinyl-1-methylimidazole, N-vinyl-4-vinyl-5-methylimidazole or quaternized derivatives thereof.
b5) R¹, R², R³ denotes hydrogen, C₁-C₄-alkyl, C₆-aryl, C₇-C₁₀-alkylaryl or a radical of the general formula VI
   R⁴ denotes a radical of the general formula VI 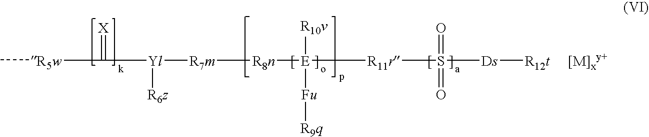
   R⁵, R⁷, R⁸, R¹¹ each denote C₁-C₆-alkyl, C₆-aryl, C₇-C₁₀-alkylaryl
   R⁶, R¹² each denote hydrogen, C₁-C₄-alkyl, C₆-aryl
   R⁹, R¹⁰ each denote hydrogen, C₁-C₄-alkyl, C₆-aryl, C₇-C₁₀-alkylaryl
   X denotes O
   E, F, Y, D each denote O, N, S
   M denotes an element of group 1, 2 or 13 of the periodic table
   a, k, l, s each denote 0 or 1
   m, n, r, w each denote an integer between 0 and 10
   o denotes an integer between 0 and 3
   p denotes an integer between 0 and 20
   q, t, u, v, z each denote an integer between 0 and 2
   x denotes 0, ⅓, ½, 1 and
   y an integer between 1 and 3 with the proviso that at least one of R¹, R², R³ and R⁴ but not more than 2 denote the general formula VI.

Preferably, b5) is vinylamine (VAm), 2-acrylamido-2-methylpropanesulfonic acid (AMPS), methacryloylamidopropyldimethylammonium propylsulfobetaines (SPPs), potassium(3-sulfopropyl)acrylate (SPA), dipotassium bis-(3-sulfopropyl)itaconate (SPI), potassium(3-sulfopropyl)methacrylate (SPM), sodium 3-allyloxy-2-hydroxypropane-1-sulfonate (SPAE), vinylbenzenesulfonic acid (VBS), vinylsulfonic acid (VS), 2-acrylamido-2-methylethanesulfonic acid, methacryloylamidoethyldimethylammonium propylsulfobetaines, methacryloylamidoethyldimethylammonium ethylsulfobetaines, sodium(3-sulfopropyl)acrylate, potassium(3-sulfoethyl)acrylate, sodium(3-sulfoethyl)acrylate, disodium bis(3-sulfopropyl)itaconate, dipotassium bis(3-sulfoethyl)itaconate, disodium bis(3-sulfoethyl)itaconate, potassium(3-sulfoethyl)methacrylate, sodium(3-sulfopropyl)methacrylate, sodium(3-sulfoethyl)methacrylate, potassium 3-allyloxy-2-hydroxypropane-1-sulfonate, sodium 3-allyloxy-2-hydroxyethane-1-sulfonate, potassium 3-allyloxy-2-hydroxyethane-1-sulfonate.

The fraction of comonomers b) in copolymer A is in the range from 1% to 40% by weight, preferably in the range from 3% to 30% by weight and more preferably in the range from 5% to 25% by weight.

It will be appreciated that it is also possible to use mixtures of two or more comonomers as long as the sum total of the fraction of these comonomers does not exceed 40% by weight.

The use of N-vinylpyrrolidone as monomer a) and vinylimidazole or quaternized vinylimidazole as monomer b) provides polymers having good properties. Advantageously, when N-vinylpyrrolidone is used as monomer a) and vinylimidazole or quaternized vinylimidazole as monomer b), a further monomer or a mixture of further monomers selected from the monomers a) and/or b), is used for copolymerization.

Unless otherwise stated, a C₁-C₄-alkyl radical is a methyl, ethyl, propyl, isopropyl, butyl, isobutyl or a tert-butyl radical.

C₁-C₆-Alkyl is to be understood as meaning methyl, ethyl, propyl, isopropyl, butyl, isobutyl, tert-butyl, pentyl, hexyl, 1-methylbutyl, 2-methylbutyl, 3-methylbutyl, 1,1-dimethylpropyl, 1,2-dimethylpropyl, 2,2-dimethylpropyl, 1-ethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1-ethylmethylpropyl or 1,2-ethylmethylpropyl.

C₁-C₁₅-Alkyl is to be understood as meaning methyl, ethyl, propyl, isopropyl, butyl, isobutyl, tert-butyl, pentyl, 1-methyl butyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1-ethylmethylpropyl or 1,2-ethylmethylpropyl and also heptyl, octyl, nonyl, decyl, undecyl, dodecyl, tridecyl, tetradecyl, pentadecyl or structural isomers thereof.

C₆-C₁₀-Aryl is to be understood as meaning phenyl and napthyl radicals.

C₇-C₁₄-Alkylaryl is to be understood as meaning singly and multiply alkyl-substituted phenyl and naphthyl radicals with the C1-C8-alkyl radicals methyl, ethyl, propyl, isopropyl, butyl, isobutyl, tert-butyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1-ethylmethylpropyl, 1,2-ethylmethylpropyl and also heptyl and octyl subject to the proviso that the carbon atoms number from 7 to 14 in total.

C₁-C₄-Alkenyl is to be understood as meaning vinyl, allyl, 1-methylvinyl, E-2-propenyl, Z-2-propenyl, 1-butenyl, 2-butenyl, 3-butenyl, 1-methyl-2-propenyl, 2-methyl-2-propenyl, 2-methyl-1-propenyl, Z-1-methyl-1-propenyl, E-1-methyl-1-propenyl.

Halogen is to be understood as meaning chlorine, bromine and iodine.

Group 1 elements are to be understood as meaning lithium, sodium or potassium.

Group 2 elements are to be understood as meaning magnesium, calcium, strontium or barium.

Group 13 elements are to be understood as meaning aluminum, gallium or indium.

The monoethylenically unsaturated carboxylic acids can be used in the copolymerization in the form of the free acid and, if they exist, the anhydrides or in partially or fully neutralized form. Neutralization is preferably effected using alkali metal or alkaline earth metal bases, ammonia or amines, for example aqueous sodium hydroxide solution, aqueous potassium hydroxide solution, sodium carbonate, potassium carbonate, sodium bicarbonate, magnesium oxide, calcium hydroxide, calcium oxide, gaseous or aqueous ammonia, triethylamine, ethanolamine, diethanolamine, triethanolamine, morpholine, diethylenetriamine, aminomethylpropanol, 2-amino-2-methylpropanol or tetraethylenepentamine.

In addition to the inventive copolymers, the membranes can contain one or more hydrophilic polymers C selected from the group of the polyvinylpyrrolidones, polyethylene glycols, polyglycol monoesters, polyethylene glycol-propylene glycol copolymers, water-soluble cellulose derivatives and the polysorbates. These hydrophilic polymers C can be used in amounts from 0% to 50% by weight, preferably from 0.01% to 40% by weight, and more preferably from 0.1% to 30% by weight in the preparation of the membranes. The weight percentages are based on the total mass of the polymers used in membrane production. Polyvinylpyrrolidones are preferred for use as polymers C.

As a further component D, the inventive membranes can contain one or more polymers selected from the group of the polysulfones such as polysulfone, polyethersulfones, polyarylethersulfones, polyarylsulfones, the polycarbonates, polyolefins, polyimides, polyketones, polyetherketones, polyetheretherketones, polyester, polyamides, polyvinyl chloride, polybutylene terephthalate, hydrophobically modified acrylic acid polymers, polyethers, polyurethanes, polyurethane copolymers or hydrophobically modified polymers such as for example water-insoluble cellulose derivatives such as cellulose acetates, cellulose nitrates and mixtures thereof. The preparation of these polymers is common knowledge. They can be used in amounts from 50% to 99% by weight and preferably from 60% to 97% by weight in the preparation of the membranes, based on the total mass of the polymers used. Preference is given to using polysulfones, polyamides or blends of polysulfones and polyamides.

The inventive copolymers can be used in amounts from 1% to 50% by weight and preferably from 1% to 40% by weight in the preparation of the membranes, based on the total mass of the polymers used.

It will be appreciated that the amounts employed of polymers C, polymers D and of the inventive copolymer are chosen so that the sum total of polymers used in the preparation of the membranes is 100% by weight.

Preference is given to using copolymers of N-vinylpyrrolidone with vinylamine, maleic acid, acrylic acid, methacrylic acid, crotonic acid, 4-pentenoic acid, 10-undecenoic acid, maleic anhydride, glycidyl methacrylate or 2-acrylamido-2-methylpropanesulfonic acid.

The invention further provides likewise novel copolymers obtainable by polymerization of
a) from 60% to 99% by weight of N-vinylpyrrolidone and
b) from 1% to 40% by weight of 3-allyloxy-2-hydroxypropane-1-sulfonate, its salts,
   copolymers obtainable by polymerization of
a) from 60% to 99% by weight of N-vinylpyrrolidone and
b) from 1% to 40% by weight of bis(3-sulfopropyl)itaconate, its salts, and
   copolymers obtainable by polymerization of
a) from 60% to 99% by weight of N-vinylpyrrolidone and
b) from 1% to 40% by weight of methacrylioylamidopropyldimethylammonium propylsulfobetaines.

The invention likewise provides semipermeable membranes comprising the inventive polymers.

The copolymers are prepared according to known processes, for example solution, precipitation, emulsion or inverse suspension polymerization, using compounds which form free radicals under the polymerization conditions.

The polymerization temperatures are customarily in the range from 30 to 200, preferably from 40 to 110° C.

Useful initiators include for example azo and peroxy compounds and also the customary redox initiator systems, such as combinations of hydrogen peroxide and reducing compounds, for example sodium sulfite, sodium bisulfite, sodium formaldehydesulfoxylate and hydrazine and also combinations of hydrogen peroxide or organic peroxides with catalytic amounts of metal, metal salts or metal complexes.

The copolymers A have K values of at least 20, preferably in the range from 25 to 120 and more preferably in the range from 40 to 110. The K values are determined after H. Fikentscher, Cellulose-Chemie, Volume 13, 58 to 64 and 71 to 74 (1932) in aqueous or alcoholic or sodium chloride solution at 25° C., at conventrations which are between 0.1% and 5%, depending on the K value range.

The average molecular weight of the polymers A used according to the invention is in the range from 30 000 to 10 000 000, preferably in the range from 35 000 to 2 000 000 and more preferably in the range from 40 000 to 1 500 000.

The polymer dispersions or solutions obtained are convertible by various drying processes such as for example spray drying, Fluidized Spray Drying, drum drying or freeze drying into powder form from which an aqueous dispersion or suspension can again be prepared by redispersing or dissolving in water.

The copolymers used according to the present invention are in principle useful for producing a wide range of crosslinkable membrane types such as microporous membranes, for example microporous hollow fiber membranes, homogeneous membranes, symmetrical or asymmetrical membranes or solution diffusion membranes for separation. It is preferable to produce microporous or asymmetrical membranes. The inventive copolymers are by virtue of their film-forming properties also usable directly for producing membranes such as solution diffusion membranes, especially after crosslinking of the copolymers in the film.

It is similarly possible to produce filter webs or filter elements by coating fiber webs or textile wovens by means of the inventive copolymers and optionally further hydrophilic polymers C and/or hydrophobic polymers D of the abovementioned selection. Filter elements can be produced from the inventive polymers by the polymers being applied to a multidimensional nonwoven material or a multidimensional woven formed from fibers, in such a way that the manner of the coating of the nonwoven or woven produces a material which exhibit filter properties which are similar or equivalent to those of a membrane. This can also be achieved by the structure of the nonwoven or woven being such that there is a filtering effect, in which case the coating with the inventive polymers serves to modify this filtering effect by surface coating as desired, say to increase or reduce the affinity for certain substances.

Further possible uses are the coating of solid substances such as silica with the discovered copolymers for use as filter materials for example.

Inventive membranes or filters can find application in the filtration of body fluids or natural or synthetic fluids which are to be introduced into a living organism, for removal of undesired substances. Such fluids are for example blood, artificially produced blood substitutes or solutions for infusion such as specific salt and nutrient solutions.

Inventive membranes or filters can also be used to free biological or synthetic fluids from undesired substances or to achieve a separation of substances. Applications therefor are to be found for example in the medical-pharmaceutical sector in relation to the preparation of test fluids such as blood, urine, etc. for analytical purposes or in the preparation of solutions or fluids which find use for analytical purposes in the medical-pharmaceutical sector, such as salt solutions for example.

The inventive polymers can likewise be used for coating surfaces. The polymers can be used as such for this end and are applied to the surface in question from solution for example. Similarly, crosslinking of the polymers before or after application to the surface by known crosslinking techniques can be utilized.

Also possible, and encompassed by the invention, are of course the crosslinking of the inventive polymers according to known methods. The crosslinking can take place during the polymerization, for example by addition of crosslinkers. Preferable, however, is the subsequent crosslinking by known methods such as for example crosslinking by means of high-energy radiation such as for example UV or gamma radiation or thermally induced crosslinking. The crosslinking can be enhanced by using auxiliaries such as thermally activable, UV-activable etc. crosslinkers.

A further use is the use of the inventive polymers for increasing the solubility of sparingly soluble or readily crystallizing substances in aqueous organic media. Crystallization inhibition has various uses, for example in oil production to inhibit the formation of gas hydrates in pipelines or to formulate sparingly soluble, readily crystallizing active compounds in the pharma or agro sector.

The present invention also encompasses the binding of substances by chemical reaction or by strong physical interactions with the functional groups of the comonomers in the vinylpyrrolidone copolymer and also the utilization of the properties of the bound substances, the action of bound enzymes for example.

There are also further possible uses for the copolymers according to the present invention, for example as membranes for technical applications, surface coating, solution mediators, solubilizers, in cosmetics, for pharmaceutical applications, as additives for emulsions or suspensions, as additives for reactive coating systems, as kinetic gas hydrate inhibitors, etc.

In general, membranes or shaped articles are produced by transferring the various components into a solution which is then shaped in a suitable way such as casting or spinning.

The membranes are produced in a conventional manner, for example by a phase inversion process as described in EP-A 082 433, incorporated herein by reference.

It is also possible to obtain hollow fiber membranes, by extrusion and coagulation of a polymer-containing spinning solution. Such a process is described for example in EP-A 168 783, which is likewise incorporated herein by reference.

It has been determined that, surprisingly, use of the copolymers in conjunction with Ultrason® as a blend provides an equivalent or even increased hydrophilicity for the membrane surface and also a large number of reactive groups on the surface. At the same time, the morphology of the porous membrane is not adversely affected.

Surprisingly, the copolymers used also exhibit good crosslinkability and adhesion on surfaces, so that a surface coating can be produced. There is also the successful use as a solubilizer for substances which are sparingly soluble or tend to crystallize in aqueous media. In addition, the copolymers also exhibit good compatibility in polymers which can be used for technical membranes such as solution diffusion membranes for separation in that the use of the copolymers provided a distinct improvement in the separating properties. The copolymers are by virtue of film formation also useful directly for producing membranes without addition of further polymers, especially after crosslinking of copolymers in the film.

The examples which follow illustrate the process of the present invention.

### EXAMPLES

Workup of copolymer solutions which contains salts of acidic comonomers: polymer solutions are adjusted to pH 2 with hydrochloric acid (37%) before freeze drying.

Preparation of Spinning Solutions:

Composition:

7.5% of copolymer
12.5% of polyethersulfone
80.0% of N-methylpyrrolidone

Components are dissolved by stirring at 70° C.

K Value:

Viscometer: Schott, type I
Measuring condition: 25° C. (±0.1° C.)
Measuring solution: 0.1 to 1 g/100 mL
   Viscosity Measurement:
Measuring system: Brookfield rotary viscometer, type DV II; spindle type 4
Speed: 30 revolutions per minute
Measuring condition: 25° C.
Measuring solution: spinning solution (7.5% of copolymer, 12.5% of polyethersulfone; 80.0% of N-methylpyrrolidone)
   Determination of Residual Monomer by Gas Chromatography
Column: DB WAX (0.5 μm, 30 m)
Carrier gas: Helium
Flow: 1 mL per minute
Starting temperature: 140° C.
Final temperature: 240° C.
Heating rate: 4° C. per minute
Measuring condition: 1 g of polymer solution with 3.5 mL of standard solution (1.2 mg benzonitrile/mL in 50% ethanolic solution)
Injection volume: 1 μL
   Freeze Drying
Starting temperature: −40° C.
Final temperature: 30° C.
Period: 48 hours
Vacuum: <200 mTorr
   Membrane Production
   Film Applicator
Gap width: 150 μm
Draw rate: 12.5 mm per second
Coagulation bath: completely ion-free water
   Determination of Functionality of Membranes with Acidic/Basic Copolymers
Weight: 0.5 to 1 g of membrane (accurately to 0.1 mg)
Addition: 50 mL of 0.01 M hydrochloric acid/aqueous sodium hydroxide solution
Reaction time: 16 hours
Workup: Filtration via fluted filter, 25 mL filtrate used for analysis Titroprocessor
Speed: 0.1 mL/minute
   Preparation Examples for Copolymers

### Example 1

### Vinylpyrrolidone/Acrylic Acid 90:10

1 L Reaction Vessel with Anchor Stirrer

Procedure:

| Assignment | Ingredient | Amount | | Content |
|---|---|---|---|---|
| Initial | Feed 1 | 40.00 | g | 100.000 |
| charge | completely ion-free water | 200.00 | g | 100.000 |
| Feed 1 | completely ion-free water | 200.00 | g | 100.000 |
| | vinylpyrrolidone | 180.00 | g | 100.000 |
| | sodium acrylate | 53.30 | g | 37.500 |
| Feed 2 | Wako V 50 | 2.00 | g | 100.000 |
| | completely ion-free water | 120.00 | g | 100.000 |
| Feed 3 | completely ion-free water | 75.00 | g | 100.000 |
| | hydrochloric acid | 25.00 | g | 37.000 |

The initial charge was heated to 60° C. under nitrogen. At 60° C., feed 1 was added over 2 hours and feed 2 over 3 hours. This was followed by heating to 75° C. and supplementary polymerization for 3 hours. This was followed by addition of feed 3 and stirring for 30 min.

Analysis:

| Appearance: | yellow, medium viscous | |
|---|---|---|
| Solids content: | 25.3% | |
| K value: | 72.5 | |
| VP residue: | — | |
| Limiting viscosity: | 0.9487 | 100 mL/g |
| Membrane functionality | 0.074 | meq/g |

### Example 2

### Vinylpyrrolidone/Acrylic Acid 90:10

1 L Reaction Vessel with Anchor Stirrer

Procedure:

| Assignment | Ingredient | Amount | | Content % | Note |
|---|---|---|---|---|---|
| Initiator | tert-butyl peroctoate | 0.33 | g | 100.000 | |
| 1 | ethyl acetate ace- | 4.67 | g | 100.000 | |
| Initiator | tert-butyl peroctoate | 1.00 | g | 100.000 | |
| 2 | ethyl acetate | 4.00 | g | 100.000 | |
| Initial | ethyl acetate | 164.00 | g | 100.000 | |
| charge | Lutonal A 50 | 2.00 | g | 40.000 | (in butyl |
| | | | | | acetate) |
| Feed 1 | ethyl acetate | 78.00 | g | 100.000 | |
| | vinylpyrrolidone | 180.00 | g | 100.000 | |
| Feed 2 | ethyl acetate | 100.00 | g | 100.000 | |
| | acrylic acid | 20.00 | g | 100.000 | |
| Feed 3 | Initiator 1 | 1.00 | ml | 100.000 | |
| Feed 4 | Initiator 1 | 1.00 | ml | 100.000 | |
| Feed 5 | Initiator 2 | 1.00 | ml | 100.000 | |
| Feed 6 | Initiator 2 | 1.00 | ml | 100.000 | |
| Feed 7 | Initiator 2 | 1.00 | ml | 100.000 | |

The initial charge was heated up to 75° C. under nitrogen. This was followed by the addition of feeds 1 and 2 over 4 hours and feed 3 was added all at once. Feeds 4, 5, 6 and 7 were added respectively each after a further hour. This was followed by one hour of supplementary polymerization, heating to 90° C. and a further hour of supplementary polymerization.

Analysis:

| Appearance: | fine white powder | |
|---|---|---|
| K value: | 54.5 | |
| VP residue: | — | |
| Limiting viscosity: | 0.7821 | 100 mL/g |
| Membrane functionality | 0.189 | meq/g |

### Example 3

### Vinylpyrrolidone/Crotonic Acid 90:10

1 L Reaction Vessel with Anchor Stirrer

Procedure:

| Assignment | Ingredient | Amount | | Content | Note |
|---|---|---|---|---|---|
| Initiator | completely ion-free | 100.0 | ml | 100.000 | |
| 1 | water | | | | |
| | Wako V 50 | 5.00 | g | 100.000 | |
| Initial | completely ion-free | 200.0 | g | 100.000 | |
| charge | water | | | | |
| | crotonic acid | 18.00 | g | 100.000 | adjust to |
| | | | | | pH 8 with |
| | | | | | NaOH |
| | vinylpyrrolidone | 60.00 | g | 100.000 | |
| Feed 1 | completely ion-free | 100.0 | g | 100.000 | |
| | water | | | | |
| | crotonic acid | 2.00 | g | 100.000 | adjust to |
| | | | | | pH 8 with |
| | | | | | NaOH |
| | vinylpyrrolidone | 120.0 | g | 100.000 | |
| Feed 2 | Initiator 1 | 1.00 | ml | 100.000 | |
| Feed 3 | Initiator 1 | 1.50 | ml | 100.000 | |
| Feed 4 | Initiator 1 | 1.50 | ml | 100.000 | |
| Feed 5 | Initiator 1 | 1.50 | ml | 100.000 | |
| Feed 6 | Initiator 1 | 40.00 | ml | 100.000 | |

The initial charge was heated to 70° C. under nitrogen. At 60° C., feed 2 was added and the addition of feed 1 was commenced and completed over 3 hours. One hour after the commencement of feed 1 feed 3 was added, followed by feed 4 after a further hour and by feed 5 after a further hour still. This was followed by 1.5 hours of supplementary polymerization, addition of feed 6, heating to 85° C. and a further two hours of supplementary polymerization.

Analysis:

| Appearance: | yellow, medium viscous | |
|---|---|---|
| Solids content: | 29.3% | |
| K value: | 55 | |
| VP residue: | 592 | ppm |
| Limiting viscosity: | 0.5589 | 100 mL/g |
| Membrane functionality | 0.035 | meq/g |

### Example 4

### Vinylpyrrolidone/Methacrylic Acid 90:10

1 L Reaction Vessel with Anchor Stirrer

Procedure:

| Assignment | Ingredient | Amount | | Content | Note |
|---|---|---|---|---|---|
| Initiator | completely ion-free | 100.00 | ml | 100.000 | |
| 1 | water | | | | |
| | Wako V 50 | 5.00 | g | 100.000 | |
| Initial | vinylpyrrolidone | 120.00 | g | 100.000 | |
| charge | completely ion-free | 200.00 | g | 100.000 | |
| | water | | | | |
| | completely ion-free | 200.00 | g | 100.000 | |
| | water | | | | |
| Feed 1 | methacrylic acid | 20.00 | g | 100.000 | adjust to |
| | | | | | pH 9 with |
| | | | | | NaOH |
| | vinylpyrrolidone | 60.00 | g | 100.000 | |
| Feed 2 | Initiator 1 | 1.50 | ml | 100.000 | |
| Feed 3 | Initiator 1 | 1.50 | ml | 100.000 | |
| Feed 4 | Initiator 1 | 1.50 | ml | 100.000 | |
| Feed 5 | Initiator 1 | 1.50 | ml | 100.000 | |
| Feed 6 | Initiator 1 | 30.00 | ml | 100.000 | |

The initial charge was heated to 70° C. under nitrogen. Feed 2 was added and the addition of feed 1 was commenced and completed over 3 hours. One hour after the commencement of feed 1 feed 3 was added, followed by feed 4 after a further hour and by feed 5 after a further hour still. This was followed by 1.5 hours of supplementary polymerization, addition of feed 6, heating to 85° C. and a further two hours of supplementary polymerization.

Analysis:

| Appearance: | yellow, medium viscous | |
|---|---|---|
| Solids content: | 27.0% | |
| K value: | 97.0 | |
| VP residue: | 54 | ppm |
| Limiting viscosity: | 1.089 | 100 mL/g |
| Membrane functionality | 0.138 | meq/g |

### Example 5

### Vinylpyrrolidone/Methacrylic Acid 90:10

1 L Reaction Vessel with Anchor Stirrer

Procedure:

| Assignment | Ingredient | Amount | | Content % | Note |
|---|---|---|---|---|---|
| Initiator | completely ion-free | 50.00 | ml | 100.000 | |
| 1 | water | | | | |
| | Wako V 50 | 2.50 | g | 100.000 | |
| Initial | completely ion-free | 250.00 | g | 100.000 | |
| charge | water | | | | |
| | vinylpyrrolidone | 120.00 | g | 100.000 | |
| Feed 1 | completely ion-free | 100.00 | g | 100.000 | |
| | water | | | | |
| | methacrylic acid | 20.00 | g | 100.000 | adjust to |
| | | | | | pH 9 with |
| | | | | | NaOH |
| | vinylpyrrolidone | 60.00 | g | 100.000 | |
| Feed 2 | Initiator 1 | 1.00 | ml | 100.000 | |
| Feed 3 | Initiator 1 | 2.00 | ml | 100.000 | |
| Feed 4 | Initiator 1 | 4.00 | ml | 100.000 | |
| Feed 5 | Initiator 1 | 8.00 | ml | 100.000 | |
| Feed 6 | Initiator 1 | 35.00 | ml | 100.000 | |

The initial charge was heated to 70° C. under nitrogen. Feed 2 was added and the addition of feed 1 was commenced and completed over 3 hours. One hour after the commencement of feed 1 feed 3 was added, followed by feed 4 after a further hour and by feed 5 after a further hour still. This was followed by 1.5 hours of supplementary polymerization, addition of feed 6, heating to 85° C. and a further two hours of supplementary polymerization.

Analysis:

| Appearance: | yellow, medium viscous | |
|---|---|---|
| Solids content: | 29.7% | |
| K value: | 86.1 | |
| VP residue: | 21 | ppm |
| Limiting viscosity: | 1.009 | 100 mL/g |
| Membrane functionality | 0.109 | meq/g |

### Example 6

### Vinylpyrrolidone/Maleic Acid 90:10

1 L Reaction Vessel with Anchor Stirrer

Procedure:

| Assignment | Ingredient | Amount | | Content % | Note |
|---|---|---|---|---|---|
| Initiator | completely ion-free | 50.00 | ml | 100.000 | |
| 1 | water | | | | |
| | Wako V 50 | 2.50 | g | 100.000 | |
| Initial | completely ion-free | 200.00 | g | 100.000 | |
| charge | water | | | | |
| Feed 1 | completely ion-free | 250.00 | g | 100.000 | |
| | water | | | | |
| | maleic anhydride | 20.00 | g | 100.000 | adjust to |
| | | | | | pH 9 |
| | | | | | within- |
| Feed 2 | completely ion-free | 100.00 | ml | 100.000 | |
| | water | | | | |
| | vinylpyrrolidone | 180.00 | g | 100.000 | |
| Feed 3 | Initiator 1 | 1.00 | ml | 100.000 | |
| Feed 4 | Initiator 1 | 1.00 | ml | 100.000 | |
| Feed 5 | Initiator 1 | 1.50 | ml | 100.000 | |
| Feed 6 | Initiator 1 | 1.50 | ml | 100.000 | |
| Feed 7 | Initiator 1 | 40.00 | ml | 100.000 | |

The initial charge was heated to 70° C. under nitrogen. Feed 3 was added and feeds 1 and 2 started and added over 3 hours. One hour after the commencement of feeds 1 and 2, feed 4 was added, followed by feed 5 after a further hour and by feed 6 after a further hour still. This was followed by 1.5 hours of supplementary polymerization, addition of feed 7, heating to 85° C. and a further two hours of supplementary polymerization. Because the viscosity was high, 200 ml of water were subsequently added for dilution.

Analysis:

| Appearance: | yellow, medium viscous | |
|---|---|---|
| Solids content: | 23.6% | |
| K value: | 101.3 | |
| VP residue: | 31 | ppm |
| Limiting viscosity: | 1.1322 | 100 mL/g |
| Membrane functionality | 0.149 | meq/g |

### Example 7

### Vinylpyrrolidone/Undecenoic Acid 90:10

1 L Reaction Vessel with Anchor Stirrer

Procedure:

| Assignment | Ingredient | Amount | | Content % |
|---|---|---|---|---|
| Initiator 1 | completely ion-free water | 50.00 | ml | 100.000 |
| | Wako V 50 | 2.50 | g | 100.000 |
| Initial | completely ion-free water | 200.00 | g | 100.000 |
| charge | | | | |
| Feed 1 | completely ion-free water | 100.00 | g | 100.000 |
| | vinylpyrrolidone | 180.00 | g | 100.000 |
| Feed 2 | 10-undecenoic acid | 20.00 | g | 100.000 |
| | ammonia water | 65.00 | g | 5.000 |
| | completely ion-free water | 30.00 | g | 100.000 |
| Feed 3 | Initiator 1 | 1.00 | ml | 100.000 |
| Feed 4 | Initiator 1 | 1.50 | ml | 100.000 |
| Feed 5 | Initiator 1 | 1.50 | ml | 100.000 |
| Feed 6 | Initiator 1 | 1.50 | ml | 100.000 |
| Feed 7 | Initiator 1 | 40.00 | ml | 100.000 |

The initial charge was heated to 70° C. under nitrogen. Feed 3 was added and feeds 1 and 2 started and added over 3 hours. One hour after the commencement of feeds 1 and 2, feed 4 was added, followed by feed 5 after a further 1.75 hours and by feed 6 after a further 2.5 hours still. This was followed by 1.5 hours of supplementary polymerization, addition of feed 7, heating to 85° C. and a further two hours of supplementary polymerization.

Analysis:

| Appearance: | yellow, medium viscous | |
|---|---|---|
| Solids content: | 34.6% | |
| K value: | 56.1 | |
| VP residue: | 884 | ppm |
| Limiting viscosity: | 0.5529 | 100 mL/g |
| Membrane functionality | 0.139 | meq/g |

### Example 8

### Vinylpyrrolidone/Undecenoic Acid 80:20

1 L Reaction Vessel with Anchor Stirrer

Procedure:

| Assignment | Ingredient | Amount | | Content % | Bemerkung |
|---|---|---|---|---|---|
| Initiator | completely ion-free | 50.00 | ml | 100.000 | |
| 1 | water | | | | |
| | Wako V 50 | 2.50 | g | 100.000 | |
| Initial | completely ion-free | 200.0 | g | 100.000 | |
| charge | water | | | | |
| | Feed 1 | 100.0 | g | 100.000 | |
| Feed 1 | completely ion-free | 160.0 | g | 100.000 | |
| | water | | | | |
| | 10-undecenoic acid | 40.00 | g | 100.000 | adjust to |
| | | | | | pH 9 with |
| | | | | | NH₄OH |
| | vinylpyrrolidone | 160.0 | g | 100.000 | |
| Feed 2 | Initiator 1 | 1.00 | ml | 100.000 | |
| Feed 3 | Initiator 1 | 1.50 | ml | 100.000 | |
| Feed 4 | Initiator 1 | 1.50 | ml | 100.000 | |
| Feed 5 | Initiator 1 | 1.50 | ml | 100.000 | |
| Feed 6 | Initiator 1 | 40.00 | ml | 100.000 | |

The initial charge was heated to 70° C. under nitrogen. Feed 2 was added and feed 1 started and added over 3 hours. One hour after the commencement of feed 1, feed 3 was added, followed by feed 4 after a further hour and by feed 5 after a further 1.5 hours still. This was followed by 1 hour of supplementary polymerization, addition of feed 6, heating to 85° C. and a further 2.5 hours of supplementary polymerization.

Analysis:

| | |
|---|---|
| Appearance: | red, low in viscosity |
| Solids content: | 26.0% |
| K value: | 30.6 |
| VP residue: | 30 450 ppm |
| Limiting viscosity: | — |
| Membrane functionality | — |

### Example 9

### Vinylpyrrolidone/2-acrylamido-2-methylpropanesulfonic acid—AMPS 90:10

1 L Reaction Vessel with Anchor Stirrer

Procedure:

| Assignment | Einsatzstoff | Amount | | Content % | Note |
|---|---|---|---|---|---|
| Initial | completely ion-free | 100.0 | g | 100.000 | |
| charge | water | | | | |
| Feed 1 | AMPS | 20.00 | g | 100.000 | |
| | completely ion-free | 300.0 | g | 100.000 | Dissolve |
| | water | | | | AMPS and |
| | | | | | to pH 8 |
| | | | | | with |
| | | | | | ammonia |
| | vinylpyrrolidone | 180.0 | g | 100.000 | |
| Feed 2 | completely ion-free | 30.00 | g | 100.000 | |
| | water | | | | |
| Feed 2 | Wako V 50 | 0.50 | g | 100.000 | |
| Feed 3 | completely ion-free | 5.00 | g | 100.000 | |
| | water | | | | |
| Feed 3 | Wako V 50 | 0.50 | g | 100.000 | |

The initial charge was heated to 70° C. under nitrogen. Feeds 1 and 2 were started and added over 3.5 hours. After one hour, feed 3 was added for a supplementary polymerization of 2 hours. The batch was diluted with 100 ml of water because of the high solution viscosity.

Analysis:

| Appearance: | clear, highly viscous | |
|---|---|---|
| Solids content: | 27.6% | |
| K value: | 86.3 | |
| VP residue: | 15 | ppm |
| Limiting viscosity: | — | |
| Membrane functionality | 0.045 | meq/g |

### Example 10

### Vinylpyrrolidone/AMPS 80:20

1 L Reaction Vessel with Anchor Stirrer

Procedure:

| Assignment | Ingredient | Amount | | Content % | Note |
|---|---|---|---|---|---|
| Initiator | Wako V 50 | 2.50 | g | 100.000 | |
| 1 | | | | | |
| Initiator | completely | 50.00 | ml | 100.000 | |
| 1 | ion-free | | | | |
| | water | | | | |
| Initial | completely | 250.00 | g | 100.000 | |
| charge | ion-free | | | | |
| | water | | | | |
| Feed 1 | AMPS | 40.00 | g | 100.000 | |
| Feed 1 | completely | 300.00 | g | 100.000 | Dissolve |
| | ion-free | | | | AMPS and |
| | water | | | | adjust to |
| | | | | | pH 8 with |
| | | | | | ammonia (5%) |
| Feed 1 | vinyl- | 160.00 | g | 100.000 | |
| | pyrrolidone | | | | |
| Feed 2 | Initiator 1 | 1.00 | ml | 100.000 | |
| Feed 3 | Initiator 1 | 1.50 | ml | 100.000 | |
| Feed 4 | Initiator 1 | 1.50 | ml | 100.000 | |
| Feed 5 | Initiator 1 | 1.50 | ml | 100.000 | |
| Feed 6 | Initiator 1 | 1.50 | ml | 100.000 | |
| Feed 7 | Initiator 1 | 40.00 | ml | 100.000 | |

The initial charge was heated to 70° C. under nitrogen. Feed 2 was added and feed 1 was started and added over 3.5 hours. 1.5 hours after the commencement of feed 1, feed 3 was added, followed by feed 4 after a further hour, by feed 5 after a further 1.5 hours still. This was followed by 1.5 hours of supplementary polymerization, addition of feed 6, heating to 85° C. and a further 2.5 hours of supplementary polymerization.

Analysis:

| Appearance: | clear, highly viscous | |
|---|---|---|
| Solids content: | 26.1% | |
| K value: | 74.0 | |
| VP residue: | 75 | ppm |
| Limiting viscosity: | — | |
| Membrane functionality | 0.014 | meq/g |

### Example 11

### Vinylpyrrolidone/Sodium 3-sulfopropyl acrylate (SPA) 80:20

Apparatus: 1 L Reaction Vessel with Anchor Stirrer

Procedure:

| Assignment | Ingredient | Amount | | Content % |
|---|---|---|---|---|
| Initiator | completely ion-free water | 50.00 | ml | 100.000 |
| 1 | Wako V 50 | 2.50 | g | 100.000 |
| Initial | completely ion-free water | 260.00 | g | 100.000 |
| charge | Feed 1 | 8.00 | g | 100.000 |
| | Feed 2 | 2.00 | g | 100.000 |
| Feed 1 | completely ion-free water | 100.00 | g | 100.000 |
| | vinylpyrrolidone | 160.00 | g | 100.000 |
| Feed 2 | completely ion-free water | 100.00 | g | 100.000 |
| | ammonia water | 0.40 | g | 5.000 |
| | SPA | 40.00 | g | 100.000 |
| Feed 3 | Initiator 1 | 1.00 | ml | 100.000 |
| Feed 4 | Initiator 1 | 1.50 | ml | 100.000 |
| Feed 5 | Initiator 1 | 1.50 | ml | 100.000 |
| Feed 6 | Initiator 1 | 1.50 | ml | 100.000 |
| Feed 7 | Initiator 1 | 40.00 | ml | 100.000 |

The initial charge was heated to 70° C. under nitrogen. Feed 3 was added and feeds 1 and 2 were started and added over 3 hours. One hour after commencement of feed 1 feed 4 was added, followed by feed 5 after a further hour and by feed 6 after a further hour still. This is followed by 1.5 hours of supplementary polymerization, addition of feed 7, heating to 85° C. and a further 2 hours of supplementary polymerization.

Analysis:

| Appearance: | clear, highly viscous | |
|---|---|---|
| Solids content: | 28.4% | |
| K value: | 83.4 | |
| VP residue: | 35 | ppm |
| Limiting viscosity: | — | |
| Membrane functionality | 0.026 | meq/g |

### Example 12

### Vinylpyrrolidone/Potassium bis(3-sulfopropyl) itaconate (SPI) 90:10

Apparatus: 1 L Reaction Vessel with Anchor Stirrer

Procedure:

| Assignment | Ingredient | Amount | | Content % |
|---|---|---|---|---|
| Initiator 1 | completely ion-free water | 50.00 | ml | 100.000 |
| | Wako V 50 | 2.50 | g | 100.000 |
| Initial | completely ion-free water | 260.00 | g | 100.000 |
| charge | Feed 1 | 9.00 | g | 100.000 |
| | Feed 2 | 1.00 | g | 100.000 |
| Feed 1 | completely ion-free water | 100.00 | g | 100.000 |
| | vinylpyrrolidone | 180.00 | g | 100.000 |
| Feed 2 | completely ion-free water | 120.00 | g | 100.000 |
| | ammonia water | 0.40 | g | 5.000 |
| | SPI | 20.00 | g | 100.000 |
| Feed 3 | Initiator 1 | 1.00 | ml | 100.000 |
| Feed 4 | Initiator 1 | 1.50 | ml | 100.000 |
| Feed 5 | Initiator 1 | 1.50 | ml | 100.000 |
| Feed 6 | Initiator 1 | 1.50 | ml | 100.000 |
| Feed 7 | Initiator 1 | 40.00 | ml | 100.000 |

The initial charge was heated to 70° C. under nitrogen. Feed 3 was added and feeds 1 and 2 were started and added over 3 hours. One hour after commencement of feed 1 feed 4 was added, followed by feed 5 after a further hour and by feed 6 after a further hour still. This is followed by 1.5 hours of supplementary polymerization, addition of feed 7, heating to 85° C. and a further 2 hours of supplementary polymerization.

Analysis:

| Appearance: | clear, medium viscous | |
|---|---|---|
| Solids content: | 27.7% | |
| K value: | 71.0 | |
| VP residue: | 115 | ppm |
| Limiting viscosity: | — | |
| Membrane functionality | 0.016 | meq/g |

### Example 13

### Vinylpyrrolidone/Sodium 3-allyloxy-2-hydroxypropane-1-sulfonate, (SPAE) 90:10

Apparatus: 1 L Reaction Vessel with Anchor Stirrer

Procedure:

| Assignment | Ingredient | Amount | | Content % |
|---|---|---|---|---|
| Initiator 1 | completely ion-free water | 50.00 | ml | 100.000 |
| | Wako V 50 | 2.50 | g | 100.000 |
| Initial | completely ion-free water | 240.00 | g | 100.000 |
| charge | Feed 1 | 9.00 | g | 100.000 |
| | Feed 2 | 1.00 | g | 100.000 |
| Feed 1 | completely ion-free water | 100.00 | g | 100.000 |
| | vinylpyrrolidone | 180.00 | g | 100.000 |
| Feed 2 | SPAE | 50.00 | g | 40.000 |
| Feed 3 | Initiator 1 | 1.00 | ml | 100.000 |
| Feed 4 | Initiator 1 | 1.50 | ml | 100.000 |
| Feed 5 | Initiator 1 | 1.50 | ml | 100.000 |
| Feed 6 | Initiator 1 | 1.50 | ml | 100.000 |
| Feed 7 | Initiator 1 | 40.00 | ml | 100.000 |

The initial charge was heated to 70° C. under nitrogen. At 60° C., feed 3 was added and feeds 1 and 2 were started and added over 3 hours. One hour after commencement of feed 1 feed 4 was added, followed by feed 5 after a further hour and by feed 6 after a further hour still. This is followed by 1.5 hours of supplementary polymerization, addition of feed 7, heating to 85° C. and a further 2 hours of supplementary polymerization.

Analysis:

| Appearance: | clear, medium viscous | |
|---|---|---|
| Solids content: | 30.6% | |
| K value: | 73.1 | |
| VP residue: | 70 | ppm |
| Limiting viscosity: | — | |
| Membrane functionality | 0.027 | meq/g |

### Example 14

### Vinylpyrrolidone/vinylbenzenesulfonic acid (VBS) 80:20

Apparatus: 1 L Reaction Vessel with Anchor Stirrer

Procedure:

| Assignment | Ingredient | Amount | | Content % |
|---|---|---|---|---|
| Initiator 1 | completely ion-free water | 50.00 | ml | 100.000 |
| | Wako V 50 | 2.50 | g | 100.000 |
| Initial | vinylpyrrolidone | 100.00 | g | 100.000 |
| charge | completely ion-free water | 200.00 | g | 100.000 |
| Feed 1 | completely ion-free water | 250.00 | g | 100.000 |
| | sodium vinylbenzenesulfonate | 44.80 | g | 100.000 |
| | vinylpyrrolidone | 60.00 | g | 100.000 |
| Feed 2 | Initiator 1 | 1.00 | ml | 100.000 |
| Feed 3 | Initiator 1 | 1.50 | ml | 100.000 |
| Feed 4 | Initiator 1 | 1.50 | ml | 100.000 |
| Feed 5 | Initiator 1 | 1.50 | ml | 100.000 |
| Feed 6 | Initiator 1 | 30.00 | ml | 100.000 |

The initial charge was heated to 70° C. under nitrogen. At 60° C., feed 2 was added and feed 1 was started and added over 3 hours. One hour after commencement of feed 1, feed 3 was added, followed by feed 4 after a further hour and by feed 5 after a further hour still. This was followed by 1.5 hours of supplementary polymerization, addition of feed 6, heating to 85° C. and a further 2 hours of supplementary polymerization.

Analysis:

| Appearance: | clear, medium viscous | |
|---|---|---|
| Solids content: | 29.5% | |
| K value: | 68.5 | |
| VP residue: | 100 | ppm |
| Limiting viscosity: | — | |
| Membrane functionality | 0.038 | meq/g |

### Example 15

### Vinylpyrrolidone/Vinylsulfonic acid 90:10

Apparatus: 1 L Reaction Vessel with Anchor Stirrer

Procedure:

| Assignment | Ingredient | Amount | | Content % | Note |
|---|---|---|---|---|---|
| Initiator | completely ion-free | 100.00 | ml | 100.000 | |
| 1 | water | | | | |
| | Wako V 50 | 5.00 | g | 100.000 | |
| Initial | ammonia water | 0.30 | g | 100.000 | |
| charge | completely ion-free | 200.00 | g | 100.000 | |
| | water | | | | |
| Feed 1 | completely ion-free | 200.00 | g | 100.000 | |
| | water | | | | |
| | sodium | 80.00 | g | 25.000 | adjust to |
| | vinylsulfonate | | | | pH 8 with |
| | | | | | HCl |
| | vinylpyrrolidone | 180.00 | g | 100.000 | |
| Feed 2 | Initiator 1 | 1.00 | ml | 100.000 | |
| Feed 3 | Initiator 1 | 1.50 | ml | 100.000 | |
| Feed 4 | Initiator 1 | 1.50 | ml | 100.000 | |
| Feed 5 | Initiator 1 | 1.50 | ml | 100.000 | |
| Feed 6 | Initiator 1 | 40.00 | ml | 100.000 | |

The initial charge was heated to 70° C. under nitrogen. At 60° C., feed 2 was added and feed 1 was started and added over 3 hours. One hour after commencement of feed 1 feed 3 was added, followed by feed 4 after a further hour and by feed 5 after a further hour still. This was followed by 1.5 hours of supplementary polymerization, addition of feed 6, heating to 85° C. and a further 2 hours of supplementary polymerization.

Analysis:

| Appearance: | pale yellow, medium viscous | |
|---|---|---|
| Solids content: | 32.7% | |
| K value: | 76.3 | |
| VP residue: | 23 | ppm |

| | |
|---|---|
| Limiting viscosity: | — |
| Membrane functionality | formation of gel particles |

### Example 16

### Vinylpyrrolidone/Methacryloylamidopropyldimethylammonium propylsulfobetaines SPP 90:10

Apparatus: 1 L Reaction Vessel with Anchor Stirrer

Procedure:

| Assignment | Ingredient | Amount | | Content % |
|---|---|---|---|---|
| Initiator 1 | completely ion-free water | 50.00 | ml | 100.000 |
| | Wako V 50 | 2.50 | g | 100.000 |
| | completely ion-free water | 170.00 | g | 100.000 |
| Initial | Feed 1 | 9.00 | g | 100.000 |
| charge | Feed 2 | 1.00 | g | 100.000 |
| Feed 1 | completely ion-free water | 100.00 | g | 100.000 |
| | vinylpyrrolidone | 180.00 | g | 100.000 |
| | completely ion-free water | 100.00 | g | 100.000 |
| Feed 2 | ammonia water | 0.40 | g | 5.000 |
| | SPP | 20.00 | g | 100.000 |
| Feed 3 | Initiator 1 | 1.00 | ml | 100.000 |
| Feed 4 | Initiator 1 | 1.50 | ml | 100.000 |
| Feed 5 | Initiator 1 | 1.50 | ml | 100.000 |
| Feed 6 | Initiator 1 | 1.50 | ml | 100.000 |
| Feed 7 | Initiator 1 | 40.00 | ml | 100.000 |

The initial charge was heated to 70° C. under nitrogen. At 60° C., feed 3 was added and feeds 1 and 2 were started and added over 3 hours. One hour after commencement of feed 1, feed 4 was added, followed by feed 5 after a further hour, and by feed 6 after a further hour still. This was followed by 1.5 hours of supplementary polymerization, addition of feed 7, heating to 85° C. and a further 2 hours of supplementary polymerization. The batch was diluted with 200 ml of water owing to the high solution viscosity.

Analysis:

| | |
|---|---|
| Appearance: | clear, highly viscous |
| Solids content: | 24.5% |
| K value: | 90.5 |
| VP residue: | 13 ppm |
| Limiting viscosity: | — |
| Membrane functionality | no suitable method for determination |

### Example 17

### Vinylpyrrolidone/Glycidyl methacrylate GMA 90:10 Precipitation Polymerization

Apparatus: 1 L Reaction Vessel with Anchor Stirrer

Procedure:

| Assignment | Ingredient | Amount | | Content | Note |
|---|---|---|---|---|---|
| Initiator | tert-butyl peroctoate | 0.33 | g | 100.000 | |
| 1 | ethyl acetate | 4.67 | g | 100.000 | |
| Initiator | tert-butyl peroctoate | 1.00 | g | 100.000 | |
| 2 | ethyl acetate | 4.00 | g | 100.000 | |
| Initial | Lutonal A 50 | 2.00 | g | 40.000 | (in butyl |
| charge | | | | | acetate) |
| | ethyl acetate | 164.00 | g | 100.000 | |
| Feed 1 | ethyl acetate | 78.00 | g | 100.000 | |
| | vinylpyrrolidone | 180.00 | g | 100.000 | |
| Feed 2 | ethyl acetate | 100.00 | g | 100.000 | |
| | glycidyl methacrylate | 20.00 | g | 100.000 | |
| Feed 3 | Initiator 1 | 1.00 | ml | 100.000 | |
| Feed 4 | Initiator 1 | 1.00 | ml | 100.000 | |
| Feed 5 | Initiator 2 | 1.00 | ml | 100.000 | |
| Feed 6 | Initiator 2 | 1.00 | ml | 100.000 | |
| Feed 7 | Initiator 1 | 1.00 | ml | 100.000 | |
| Feed 8 | Initiator 1 | 1.00 | ml | 100.000 | |

The initial charge was heated to 75° C. under nitrogen. Feed 3 was added and feeds 1 and 2 were started and added over 4 hours. One hour after commencement of feed 1, feed 4 was added, followed by feed 5 after a further hour, by feed 6 after a further hour still, by feed 7 after yet a further hour and by feed 8 after yet another further hour. This is followed by heating to 90° C. and one hour of supplementary polymerization.

This produced a viscoelastic substance which was no longer castable. The first precipitate appeared after a polymerization time of 4 hours.

Analysis:

| | |
|---|---|
| Appearance: | white rubbery substance |
| K value: | 55.5 |
| Limiting viscosity: | — |
| Membrane functionality | 0.163 meq/g |

### Example 18

### Vinylpyrrolidone/Gycidyl methacrylate GMA 80:20 Precipitation polymerization

Apparatus: 1 L Reaction Vessel with Anchor Stirrer

Procedure:

| Assignment | Ingredient | Amount | | Content % | Note |
|---|---|---|---|---|---|
| Initiator | Wako V59 | 2.50 | g | 100.000 | |
| 1 | toluene | 50.00 | ml | 100.000 | |
| Initial | vinylpyrrolidone | 20.00 | g | 100.000 | |
| charge | toluene | 200.00 | g | 100.000 | |
| | Lutonal A 50 | 2.00 | g | 40.000 | (in butyl |
| | | | | | acetate) |
| Feed 1 | toluene | 80.00 | g | 100.000 | |
| | vinylpyrrolidone | 140.00 | g | 100.000 | |
| Feed 2 | toluene | 60.00 | g | 100.000 | |
| | glycidyl | 40.00 | g | 100.000 | |
| | methacrylate | | | | |
| Feed 3 | Initiator 1 | 1.00 | ml | 100.000 | |
| Feed 4 | Initiator 1 | 1.50 | ml | 100.000 | |
| Feed 5 | Initiator 2 | 1.50 | ml | 100.000 | |
| Feed 6 | Initiator 2 | 40.00 | ml | 100.000 | |
| Feed 7 | Initiator 2 | 3.00 | ml | 100.000 | |

The initial charge was heated to 80° C. under nitrogen. At 70° C., feed 3 was added and feeds 1 and 2 were started and added over 3 hours. One hour after commencement of feed 1, feed 4 was added, followed by feed 5 after a further hour and by feed 6 after a further hour still. This was followed by 1.5 hours of supplementary polymerization, addition of feed 7, heating to 95° C. and a further 2 hours of supplementary polymerization.

Analysis:

| | |
|---|---|
| Appearance: | white substance |
| K value: | 31.5 |
| Limiting viscosity: | — |
| Membrane functionality | 0.333 meq/g |

### Example 19

### Vinylpyrrolidone/Hydroxyethyl methacrylate HEMA 80:20

Apparatus: 1 L Reaction Vessel with Anchor Stirrer

Procedure:

| Assignment | Ingredient | Amount | | Content % |
|---|---|---|---|---|
| Initial | completely ion-free water | 200.00 | g | 100.000 |
| charge | | | | |
| Feed 1 | completely ion-free water | 200.00 | g | 100.000 |
| | hydroxyethyl methacrylate | 40.00 | g | 100.000 |
| | vinylpyrrolidone | 160.00 | g | 100.000 |
| Feed 2 | Wako V 50 | 1.00 | g | 100.000 |
| | completely ion-free water | 20.00 | g | 100.000 |
| Feed 3 | completely ion-free water | 5.00 | g | 100.000 |
| | Wako V 50 | 1.00 | g | 100.000 |

The initial charge was heated to 75° C. under nitrogen. Feeds 1 and 2 were started and added over 2 and 2.5 hours respectively. This was followed by one hour of supplementary polymerization, addition of feed 3 and a further 2 hours of supplementary polymerization.

Analysis:

| | |
|---|---|
| Appearance: | turbid, medium viscous |
| Solids content: | 29.5 |
| K value: | 62.2 |
| VP residue | 69 ppm |
| Limiting viscosity: | — |
| Membrane functionality | — |

### Example 20

### Vinylpyrrolidone/4-vinylbenzyl chloride VBC 90:10 Precipitation polymerization

Apparatus: 1 L Reaction Vessel with Anchor Stirrer

Procedure:

| | | | |
|---|---|---|---|
| Assignment | Ingredient | Amount | Content % |

| | | | | |
|---|---|---|---|---|
| Initiator 1 | Wako V59 | 1.25 | g | 100.000 |
| | toluene | 50.00 | ml | 100.000 |
| Initial | toluene | 100.00 | g | 100.000 |
| charge | vinylpyrrolidone | 9.00 | g | 100.000 |
| | vinylbenzyl chloride | 1.10 | g | 90.000 |
| Feed 1 | toluene | 50.00 | g | 100.000 |
| | vinylbenzyl chloride | 10.00 | g | 90.000 |
| | vinylpyrrolidone | 81.00 | g | 100.000 |
| Feed 2 | Initiator 1 | 5.00 | ml | 100.000 |
| Feed 3 | Initiator 1 | 5.00 | ml | 100.000 |
| Feed 4 | Initiator 1 | 5.00 | ml | 100.000 |
| Feed 5 | Initiator 1 | 5.00 | ml | 100.000 |
| Feed 6 | Initiator 1 | 20.00 | ml | 100.000 |

The initial charge was heated to 80° C. under nitrogen. At 70° C., feed 2 was added and feed 1 was started and added over 3 hours. One hour after commencement of feed 1, feed 3 was added, followed by feed 4 for a further hour and by feed 5 after a further hour still. This was followed by 1.5 hours of supplementary polymerization, addition of feed 6, heating to 95° C. and a further 2.5 hours of supplementary polymerization.

Analysis:

| | |
|---|---|
| Appearance: | clear, yellow solution |
| Solids content: | — |
| K value: | — |
| Limiting viscosity: | — |
| Membrane functionality | |

### Example 21

### Vinylpyrrolidone/Vinylamine 80/20

Apparatus: 1 L Reaction Vessel with Anchor Stirrer

Procedure:

| Assignment | Ingredient | Amount | | Content % |
|---|---|---|---|---|
| Initial | water | 935 | g | 100.000 |
| charge | vinylpyrrolidone | 200 | g | 100.000 |
| | vinylformamide | 50 | g | 100.000 |
| Feed 1 | water | 62.5 | g | 100.000 |
| | Wako V 50 | 2.5 | g | 100.000 |
| Feed 2 | ammonia water | 0.15 | ml | 25.000 |
| Feed 3 | water | 250 | ml | 100.000 |
| Feed 4 | aqueous sodium hydroxide | 112.7 | ml | 25.000 |
| | solution | | | |
| Feed 5 | hydrochloric acid | 60 | ml | 32.000 |

The initial charge was heated to 70° C. under nitrogen, the pH being monitored. Feed 1 was added over 3 hours at an internal temperature of 70° C. The pH was checked and controlled by feed 2 (rising from 6.2 to 7.4). This was followed by 3 hours of supplementary polymerization at 70° C. and a subsequent dilution with feed 3. This was followed by heating to 80° C., addition of feed 4 over one hour and a further 3 hours of stirring at 80° C. to hydrolyze vinylformamide to vinylamine. Owing to the high solution viscosity, the batch was diluted with 500 ml of water and adjusted to pH 6.9 with feed 5. The product was obtained as a powder after freeze drying.

The hydrolysis can of course also be omitted and the vinylpyrrolidone/vinylformamide copolymer isolated.

Analysis:

| | |
|---|---|
| Cl | 7.3% |
| K value | 107 |
| Na | 5.2% |
| vinylformamide residue | 5 ppm |
| vinylpyrrolidone residue | 30 ppm |
| water content | 7.4% |

### Example 22

### Vinylpyrrolidone/Vinylamine 90/10

Apparatus: 1 L Reaction Vessel with Anchor Stirrer

Procedure:

| Assignment | Ingredient | Amount | | Content % |
|---|---|---|---|---|
| Initial | water | 935 | g | 100.000 |
| charge | vinylpyrrolidone | 225 | g | 100.000 |
| | vinylformamide | 25 | g | 100.000 |
| Feed 1 | water | 62.5 | g | 100.000 |
| | Wako V 50 | 2.5 | g | 100.000 |
| Feed 2 | ammonia water | 0.15 | ml | 25.000 |
| Feed 3 | water | 250 | ml | 100.000 |
| Feed 4 | aqueous sodium hydroxide | 112.7 | ml | 25.000 |
| | solution | | | |
| Feed 5 | hydrochloric acid | 60 | ml | 32.000 |

The initial charge was heated to 70° C. under nitrogen, the pH being monitored. Feed 1 was added over 3 hours at an internal temperature of 70° C. The pH was checked and controlled by feed 2 (rising from 6.2 to 7.4). This was followed by 3 hours of supplementary polymerization at 70° C. and a subsequent elution with feed 3. This was followed by heating to 80° C., addition of feed 4 over one hour and a further 3 hours of stirring at 80° C. to hydrolyze vinylformamide to vinylamine. Owing to the high solution viscosity, the batch was diluted with 500 ml of water and adjusted to pH 6.9 with feed 5. The product was obtained as a powder after freeze drying.

The hydrolysis can of course also be omitted and the vinylpyrrolidone/vinylformamide copolymer isolated.

Analysis:

| | |
|---|---|
| Cl | 9% |
| K value | 89.3 |
| Na | 5.2% |
| Vinylformamide residue | 5 ppm |
| Vinylpyrrolidone residue | 19 ppm |
| Water content | 10.1% |

1. A copolymer comprising
a) from 60% to 99% by weight of at least one vinyllactam or N-vinylamine selected from the group consisting of N-vinylpyrrolidone, N-vinylpiperidone, N-vinylcaprolactam and N-vinylformamide, and
b) from 1% to 40% by weight of at least one monomer selected from the group consisting of glycidyl methacrylate, hydroxyethyl methacrylate, 4-vinylbenzyl chloride, 4-aminostyrene, 3-N,N-dimethylaminostyrene, 3-N,N-diethyl-aminostyrene, 3-N,N-diphenylaminostyrene, 4-N,N-dimethylaminostyrene, 4-N,N-diethylaminostyrene, 4-N,N-diphenylaminostyrene, vinylimidazole or quaternized vinylimidazole, 2-methylvinylimidazole, 4-methylvinylimidazole, 5-methylvinylimidazole or quaternized derivatives thereof, vinylamine, 2-acrylamido-2-methylpropanesulfonic acid, methacryloylamidopropyldimethylammonium propylsulfobetaines, potassium (3-sulfopropyl) acrylate, dipotassium bis-(3-sulfopropyl) itaconate, potassium (3-sulfopropyl) methacrylate, sodium 3-allyloxy-2-hydroxypropane-1-sulfonate, vinylbenzenesulfonic acid, vinylsulfonic acid, 2-acrylamido-2-methylethanesulfonic acid, methacryloylamidoethyldimethylammonium propylsulfobetaines, methacryloylamidoethyldimethylammonium ethylsulfobetaines, sodium(3-sulfopropyl)acrylate, potassium(3-sulfoethyl)acrylate, sodium(3-sulfoethyl)acrylate, disodium bis(3-sulfopropyl)itaconate, dipotassium bis(3-sulfoethyl)itaconate, disodium bis(3-sulfoethyl)itaconate, potassium(3-sulfoethyl)methacrylate, sodium(3-sulfopropyl)methacrylate, sodium(3-sulfoethyl)methacrylate, potassium 3-allyloxy-2-hydroxypropane-1-sulfonate, sodium 3-allyloxy-2-hydroxyethane-1-sulfonate and potassium 3-allyloxy-2-hydroxyethane-1-sulfonate
c) optionally, one or more hydrophilic polymers C, and
d) optionally, one or more polymers D.

2. A method of producing a membrane comprising producing the membrane with the copolymer of claim 1.

3. The method of claim 2, wherein the membrane is a solution diffusion membrane.

4. The copolymer of claim 1, wherein the copolymer comprises one or more hydrophilic polymers C, and wherein the one or more hydrophiclic polymers C are selected from the group consisting of polyvinylpyrrolidone, polyethylene glycol, polyglycol monoesters, polyethylene glycol-propylene glycol copolymers, water-soluble cellulose, polysorbates, and combinations thereof.

5. The copolymer of claim 1, wherein the copolymer comprises one or more polymers D, and wherein the one or more polymers D are selected from the group consisting of polysulfone, polyether sulfones, polyaryl ether sulfones, polyaryl sulfones, polycarbonates, polyolefins, polyimides, polyketones, polyether ketones, polyether ether ketones, polyesters, polyamides, polyvinyl chloride, hydrophobically modified acrylic acid polymers, polyethers, polyurethanes, polybutylene terephthalates, polyurethane copolymers, cellulose acetates, cellulose nitrates and mixtures thereof.

6. A membrane comprising at least one co-polymer of claim 1 and a fiber web, textile woven, or combination thereof.

7. (canceled)

8. A method of conducting dialysis comprising conducting the dialysis with the membrane of claim 6.

9. A method of filtering body fluids comprising filtering the body fluids with the membrane of claim 6.

10. A method of conducting analytical separations comprising conducting the analytical separations with the membrane of claim 6.

11. A copolymer comprising the monomeric units of, and obtained by polymerization of
a) from 60% to 99% by weight of N-vinylpyrrolidone and
b) from 1% to 40% by weight of 3-allyloxy-2-hydroxypropane-1-sulfonate or its salts.

12. A copolymer comprising the monomeric units of, and obtained by polymerization of
a) from 60% to 99% by weight of N-vinylpyrrolidone and
b) from 1% to 40% by weight of bis(3-sulfopropyl)itaconate or its salts.

13. A copolymer comprising the monomeric units of, and obtained by polymerization of
a) from 60% to 99% by weight of N-vinylpyrrolidone and
b) from 1% to 40% by weight of methacryloylamidopropyldimethyl-ammonium propylsulfobetaines.

14. (canceled)

15. The membrane of claim 6, wherein the membrane comprises more than one copolymer and wherein the copolymers are crosslinked.
